(19) United States
(12) Patent Application Publication
(10) Pub. No.: US 2006/0200420 A1
(43) Pub. Date: Sep. 7, 2006

(54) License management apparatus, control method therefor, and program for implementing the control method

(75) Inventor: Mamoru Osada, Kawasaki-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/360,371

(22) Filed: Feb. 23, 2006

(30) Foreign Application Priority Data
Feb. 24, 2005 (JP) 2005-049156

(51) Int. Cl. G06Q 99/00; H04L 9/32; G06F 12/14; G06F 17/30

(52) U.S. Cl. 705/59; 726/6; 726/18; 726/19; 726/31

(57) ABSTRACT

A license management apparatus which is capable of automatically updating a license for an application. A license information installation section stores license information concerning the license for the application. A license information update configuration section sets automatic update information concerning automatic update of the license for the application according to a input by a user. A license information management section determines, based on the license information stored by the license information installation section and the automatic update information set by the license information update configuration section, whether or not it is time for updating the license. An automatic license information issuance-requesting section requests update of the license when the license information management section determines that it is time for updating the license.

### BACKGROUND OF THE INVENTION

1. Field of the Invention

The present invention relates to a license management apparatus, a control method therefor, and a program for implementing the control method, and more particularly to a technique of updating a license for an application.

2. Description of the Related Art

Recently, in image forming apparatuses, such as multi-function-devices, an environment for executing predetermined applications has been being improved by the use of Java® techniques or the like. Multi-function devices with improved application execution environments permit users to install applications on an as-needed basis.

Application vendors have started the business of charging for applications executed on multi-function devices (see e.g. Japanese Laid-Open Patent Publication (Kokai) No. 2001-306315). Further, such businesses related to the use of applications include businesses of making profits from user's execution of applications, and businesses of granting licenses for respective applications to users and making profits from license fees.

Conventionally, in such businesses of making profits from license fees as mentioned above, each license defines an expiration date at which the license to the use of an application expires or an upper limit of use of the application, such as a predetermined number of times of execution thereof.

In the prior art, however, when a license for an application expires, the user has to manually request the licenser to issue a new license, which is inconvenient to the user.

### SUMMARY OF THE INVENTION

It is an object of the present invention to provide a license management apparatus which is capable of automatically updating a license for an application, a control method therefor, and a program for implementing the control method.

To attain the above object, according to a first aspect of the present invention, there is provided A license management apparatus incorporated in an apparatus that executes a predetermined application, the license management apparatus managing a license for the application, comprising a storage device that stores license information concerning the license for the application, a setting device that sets automatic update information concerning automatic update of the license for the application according to a input by a user, a determination device that determines, based on the license information stored by said storage device and the automatic update information set by said setting device, whether or not it is time for updating the license, and an update requesting device that requests update of the license when said determination device determines that it is time for updating the license.

With the configuration of the first aspect of the present invention, it is possible to provide a license management apparatus which is capable of automatically updating a license for an application.

Preferably, said setting device sets at least one of an automatic update expiration date of the license and a number of times of execution of the automatic update, as the automatic update information.

Preferably, said setting device sets timing in which the license is to be automatically updated before expiration of the license, as the automatic update information.

Preferably, said setting device sets information for use in notifying that the license is to be or has been automatically updated, to a predetermined destination.

More preferably, said setting means sets an electronic mail address as the information for use in the notification.

More preferably, said setting means sets information on timing in which the notification is to be executed, as the information for use in the notification.

Preferably, the license management apparatus comprises an acquisition device that is operable when a license which has been updated is issued from a server on a network in response to a request made by said update requesting-device, to acquire a fee for the license from the server.

More preferably, the license management apparatus comprises a transmission device that transmits the license fee acquired by said acquisition device to a predetermined management apparatus via the network.

More preferably, the license management apparatus comprises a printing control device that causes a printing apparatus to print the license fee acquired by said acquisition device.

More preferably, a plurality of the license management apparatuses are divided into groups by said server, and only a license management apparatus set to one representative of each group is provided with said acquisition device.

Further preferably, said acquisition device of said license management apparatus representative of each group acquires a total of fees for updates of licenses each requested by said update requesting device of each license management apparatus of the group, from the server.

To attain the above object, according to a second aspect of the present invention, there is provided a control method for a license management apparatus incorporated in an apparatus that executes a predetermined application, the license management apparatus managing a license for the application, comprising a storage step of storing license information concerning the license for the application, a setting step of setting automatic update information concerning automatic update of the license for the application according to a input by a user, a determination step of determining, based on the license information stored in said storage step and the automatic update information set in said setting step, whether or not it is time for updating the license, and an updating requesting step of requesting update of the license when it is determined in said determination step that it is time for updating the license.

To attain the above object according to a second aspect of the present invention, there is provided a program for causing a computer to execute a control method for a license management apparatus incorporated in-an apparatus that executes a predetermined application, the license management apparatus managing a license for the application, comprising a storage module for storing license information concerning the license for the application, a setting module for setting automatic update information concerning automatic update of the license for the application according to a input by a user, a determination module for determining, based on the license information stored by said storage module and the automatic update information set by said setting module, whether or not it is time for updating the license, and an updating requesting module for requesting update of the license when it is determined by said determination module that it is time for updating the license.

The above and other objects, features, and advantages of the invention will become more apparent from the following detailed description taken in conjunction with the accompanying drawings.

### BRIEF DESCRIPTION OF THE DRAWINGS

FIG. 1 is a schematic block diagram of multi-function device implementing a license management apparatus according to an embodiment of the present invention;

FIG. 2 is a diagram of the software configuration of the multi-function device;

FIG. 3 is a diagram of a network to which the multi-function device is connected;

FIG. 4 is a schematic block diagram of the hardware configuration of a PC (server) on the network;

FIG. 5 is a diagram of an example of application management information managed by the PC;

FIG. 6 is a diagram of model information managed by the PC;

FIG. 7 is a diagram of an example of license management information managed by the PC;

FIG. 8 is a diagram of license history information managed by the PC;

FIG. 9 is a diagram of property information on an application installed on the multi-function device;

FIG. 10 is a diagram of license information on the application;

FIG. 11 is a diagram of license management information managed by the multi-function device;

FIG. 12 is a diagram of a license information update configuration screen displayed on the multi-function device;

FIGS. 13A to 13C are flowcharts illustrating a process which is executed by a license information management section of the multi-function device;

FIGS. 14A and 14B are flowcharts illustrating a process which is executed by a license management section of the multi-function device;

FIG. 15 is a flowchart illustrating a process which is executed by the PC upon reception of a command from the multi-function device;

FIG. 16 is a diagram of group management information managed by the PC;

FIG. 17 is a diagram of a license fee management table managed by the PC;

FIG. 18 is a diagram of a group edit screen displayed on the PC; and

FIG. 19 is a diagram of the configuration of a license fee notification command.

### DETAILED DESCRIPTION OF THE PREFERRED EMBODIMENTS

The present invention will now be described in detail with reference to the drawings showing preferred embodiments thereof.

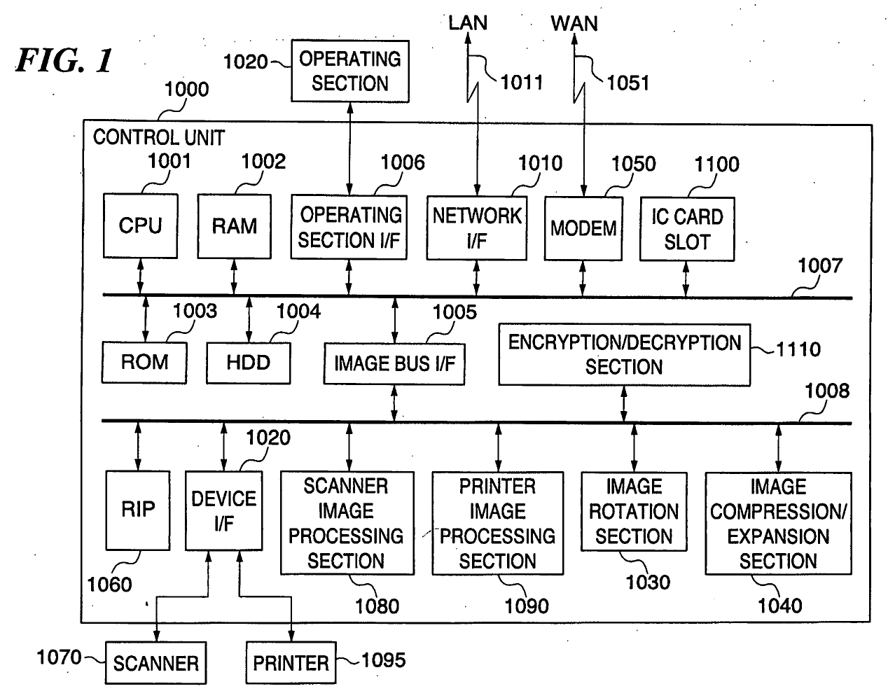

FIG. 1 is a block diagram of a multi-function device implementing a license management apparatus according to an embodiment of the present invention. The present multi-function device (hereinafter also referred to as the MFP (Multi-Function Peripheral)) performs various functions, such as the scanning function, the printing function, the copying function, and the facsimile function, with a control unit 1000 as a core.

More specifically, the control unit 1000 is connected to a scanner 1070 and a printer 1095 as well as to a LAN 1011 and a public communication line (WAN) 1051, so as to input and process image data and output the processed image data.

The control unit 1000 is provided with a system bus 1007 and an image bus 1008 interconnected via an image bus I/F 1005. The image bus I/F 1005 functions as a bus bridge for converting a data structure. The image bus 1008 is used for high-speed transfer of image data, and is implemented by a PCI bus or an IEEE 1394 bus. Connected to the system bus 1007 are a CPU 1001, a RAM 1002, a ROM 1003, a hard disk drive (HDD) 1004, an operating section I/F 1006, a network I/F 1010, a modem 1050, and an IC card slot 1100.

The CPU 1001 controls the overall operation of the multi-function device by executing programs loaded in the RAM 1002. During the control operation, the CPU 1001 uses the RAM 1002 not only as a work area, but also as an image memory for temporarily storing image data. The ROM 1003 stores a boot program for loading an OS and application programs stored in the HDD 1004 into the RAM 1002. It should be noted that the HDD 1004 also stores image data.

The operating section I/F 1006 provides interface for communication with an operating section (UI) 1012 having a touch panel. Image data to be displayed on the operating section 1012 is output to the operating section 1012 via the operating section I/F 1006, while data input via the operating section 1012 is transferred to the CPU 1001 via the operating section I/F 1006. The network I/F 1010 sends and receives data to and from each of apparatuses on the LAN 1011. The modem 1050 sends and receives data via the public communication line (WAN) 1051.

The IC card slot 1100 is used for mounting an IC card in the multi-function device. In the present embodiment, the IC card is utilized for inputting and outputting a key for use in encryption and decryption. In this case, the input and output of the encryption/decryption key is permitted only after inserting the IC card in the IC card slot 1100 and then inputting an appropriate PIN (Personal Identifier Number) code.

Connected to the image bus 1008 are a raster image processor (RIP) 1060, a device I/F 1020, a scanner image processing section 1080, a printer image processing section 1090, an image rotation section 1030, an image compression/expansion section 1040, and an encryption/decryption section 1110. The raster image processor (RIP) 1060 converts a PDL code into a bitmap image. The device I/F 1020 between the control unit 1000, and the scanner 1070 and the printer 1095, and performs synchronous-to-asynchronous or asynchronous-to-synchronous conversion of image data. The scanner image processing section 1080 corrects, processes, and edits input image data. The printer image processing section 1090 performs correction, resolution conversion, etc. of image data to be printed out, so as for the image data to conform to the printer 1095. The image rotation section 1030 rotates image data. The image compression/expansion section 1040 compresses multi-valued image data into JPEG data, and binary image data into JBIG, MMR or MH data, as well as performs expansion of the compressed data. The encryption/decryption section 1110 encrypts/decrypts data using the key on the IC card inserted in the IC card slot 1100.

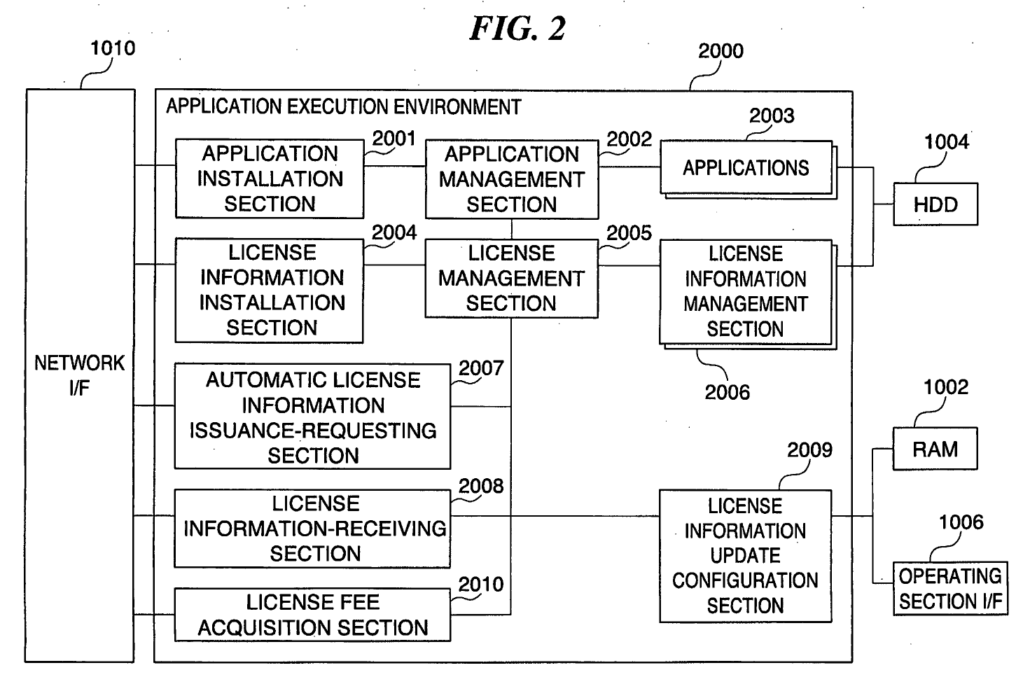

The multi-function device in FIG. 1 is provided with an application execution environment 2000 configured as shown in FIG. 2. The application execution environment 2000 execute specific applications 2003. In the present embodiment, Java® applications (Java applets and Java beans) are assumed as the specific applications 2003. The applications 2003 cause the present multi-function device to execute various kinds of processes including a printing process and a copying process.

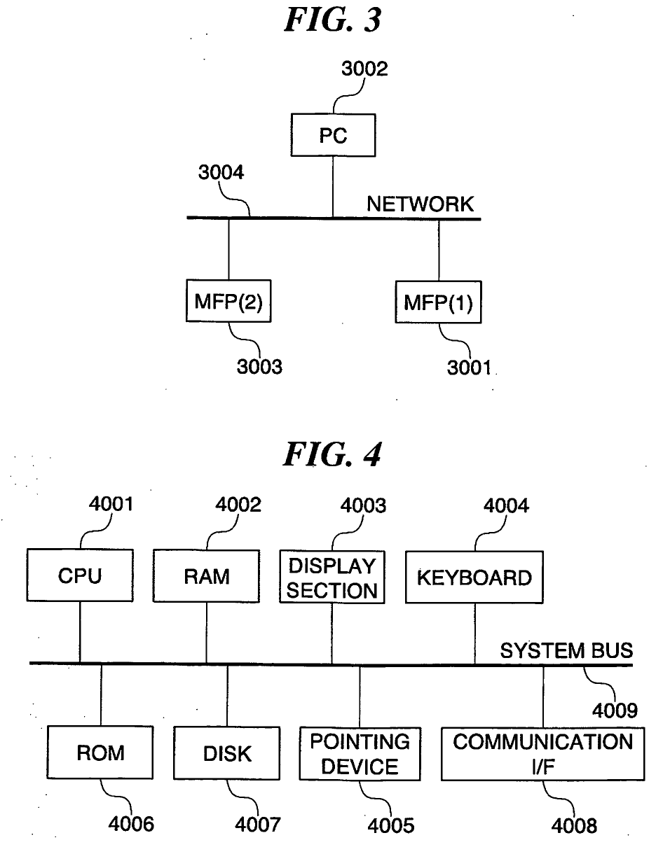

The application execution environment 2000 is comprised of the following software modules (referred to as “sections”): An application installation section 2001 installs the applications 2003 through communication with a PC (personal computer) 3002 (see FIG. 3), described hereinafter, via the network I/F 1010, and stores the same in the HDD 1004. An application management section 2002 manages the start and stop of each of applications including the applications 2003 installed by the application installation section 2001, which operate on the present multi-function device. A license information installation section 2004 communicates with the PC 3002 via the network I/F 1010 to install predetermined license information and store the same in the HDD 1004.

A license management section 2005 manages license information on an application-by-application basis. The license management section 2005 controls management of a license information management section 2006, and a license information updating process and other various kinds of processes associated with the management of license information. The license information management section 2006 manages expiration dates and the like associated with the license information installed by the license information installation section 2004. An automatic license information issuance-requesting section 2007 requests the PC 3002 in FIG. 3, via the network I/F 1010, to issue predetermined license information, in response to an instruction from the licence management section 2005. A license information-receiving section 2008 receives the license information requested by the automatic license information issuance-requesting section 2007 from the PC 3002, and passes the same to the license management section 2005.

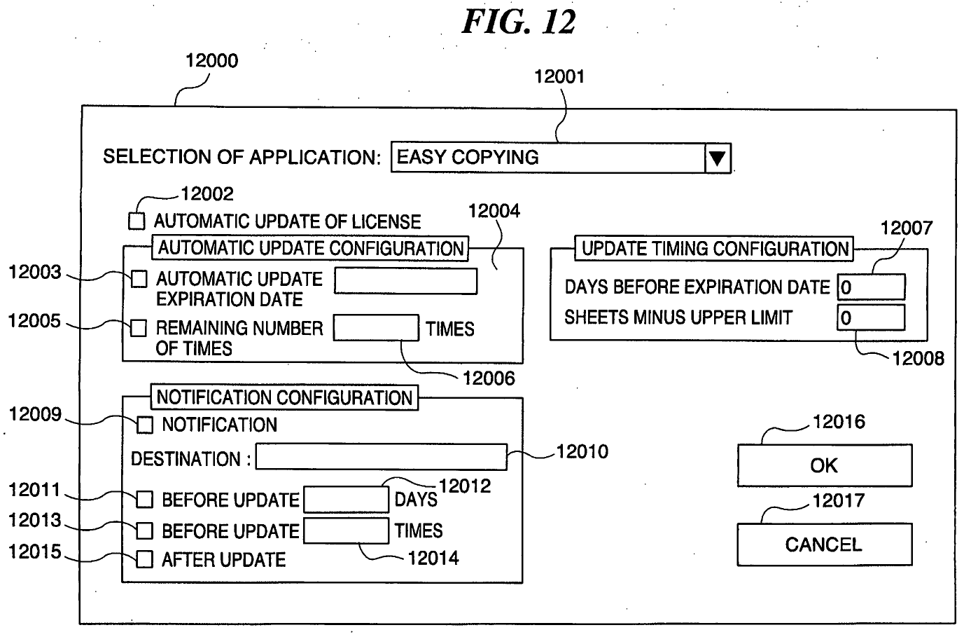

A license information update configuration section 2009 displays a user interface screen (hereinafter referred to as “the UI screen”: see FIG. 12) for configuring various settings associated with updating of license information, on a display panel of the operating section 1012 via the operating section I/F 1006, and stores settings configured on the UI screen in the RAM 1002. A license fee acquisition section 2010 sends a license fee acquisition command to the PC 3002 via the network I/F 1010 in response to an instruction from the license management section 2005 to thereby acquire a license fee from the PC 3002, and notifies the license management section 2005 that the license fee has been acquired.

Although in the present embodiment, the above described software sections are all formed on the application execution environment 2000, this is not limitative. Further, in general, in apparatuses like the multi-function device of the present embodiment, first-time installation of an application is performed together with installation of associated license information, and therefore it is possible to integrate the application installation section 2001 and the license information installation section 2004 into one section. It is also possible to integrate the license information-receiving section 2008 and the license information installation section 2004 into one section, or the license information-receiving section 2008, the license information installation section 2004, and the application installation section 2001 into one section.

Further, it is also general that license information to be installed for the first time includes information for identifying the multi-function device, and it is assumed in the present embodiment that the multi-function device identification information is properly processed by the license information installation section 2004. Furthermore, it is assumed that the multi-function device identification information is registered in the PC 3002 on the licenser side when a first-time license issuing request is made.

It should be noted that the PC 3002 is connected to a plurality of multi-function devices 3001 and 3003 configured as above via a network 3004 (corresponding to the LAN 1011 and the WAN 1051 in FIG. 1), as shown in FIG. 3, to function as a server for transmitting applications, license information, license fee information, etc. to the plurality of multi-function devices 3001 and 3003.

FIG. 4 is a block diagram of the hardware configuration of the PC 3002. As shown in FIG. 4, a CPU 4001, a RAM 4002, a display section 4003, a keyboard 4004, a pointing device 4005, a ROM 4006, a disk 4007, and a communication I/F 4008 are interconnected via a system bus 4009.

Various programs for controlling the PC 3002 are stored in the ROM 4006 or the disk 4007. The programs are read out into the RAM 4002 and executed by the CPU 4001, on an as-needed basis. More specifically, the CPU 4001 loads a program into the RAM 4002 in response to an instruction from the keyboard 4004 or the pointing device 4005, and carries out processing based on the program loaded in the RAM 4002.

It should be noted that the above-mentioned various programs also include a program for managing applications and license information, and a program for sending the applications and the license information to the multi-function devices 3001 and 3003 via the communication I/F 4008.

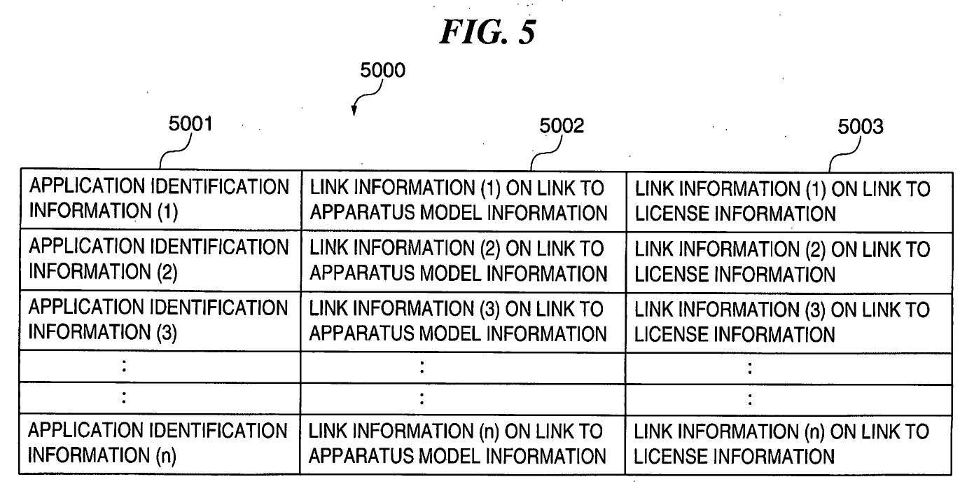

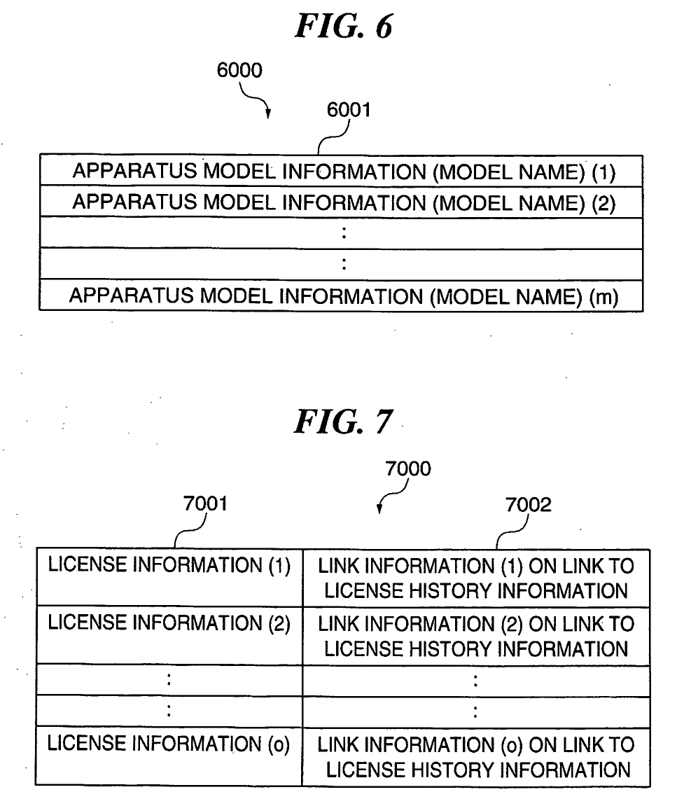

FIG. 5 shows an example of the configuration of application management information 5000 stored in the disk 4007 of the PC 3002, for managing applications. As shown in FIG. 5, the application management information 5000 is comprised of application identification information 5001 for identifying applications, link information 5002 on links to apparatus model information 6000 (see FIG. 6) on models into which the applications can be installed, and link information 5003 on links to license information 7000 (see FIG. 7) associated with licenses set for the applications.

Although in the present embodiment, UUIDs (Universal Unique IDs) are used as the application identification information 5001, other identification information, such as the names of the applications, may be used. Further, the application management information 5000 may include information on application developers in addition to the application identification information 5001, the link information 5002 on the links to the apparatus model information 6000, and the link information 5003 on the links to the license information 7000.

As shown in FIG. 6, the apparatus model information 6000 contains model names 6001 of multi-function devices. However, other information, such as sets of model names and versions, which enable unique identification of the respective models of multi-function devices, may be contained in the apparatus model information 6000.

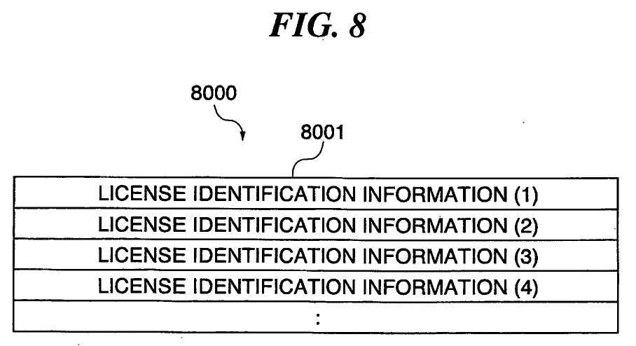

FIG. 7 shows an example of the configuration of the license management information 7000 managed by the PC 3002. Each piece of the license management information 7000 is comprised of license information 7001, i.e. the contents of a license, and link information 7002 on a link to license history information (see FIG. 8) indicative of the issue history of the license. The license information 7001 contains an expiration date, an upper limit of the number of times of printing (printing upper limit), and so forth. However, the license information 7001 can also be configured to contain other items, such as the number of times of scanning, to which an upper limit can be set. The link information 7002 is on a link to the license history information, i.e. a group of pieces of license identification information each assigned to a license when the license is issued.

FIG. 8 shows the license history information 8000 managed by the PC 3002. The license history information 8000 indicates a license identification information group (the group of pieces of license identification information 8001) each assigned to a license, as mentioned above, when the license is issued. Although in the present embodiment, UUIDs are used as the license identification information, this is not limitative, but any other suitable identification information can be used. Further, the license history information 8000 may be configured into any form insofar as the license issuance history can be managed e.g by acquiring identification information for identifying a specific multi-function device when a license is issued to the multi-function device for the first time, and adding the identification information on the multi-function device to the license history information.

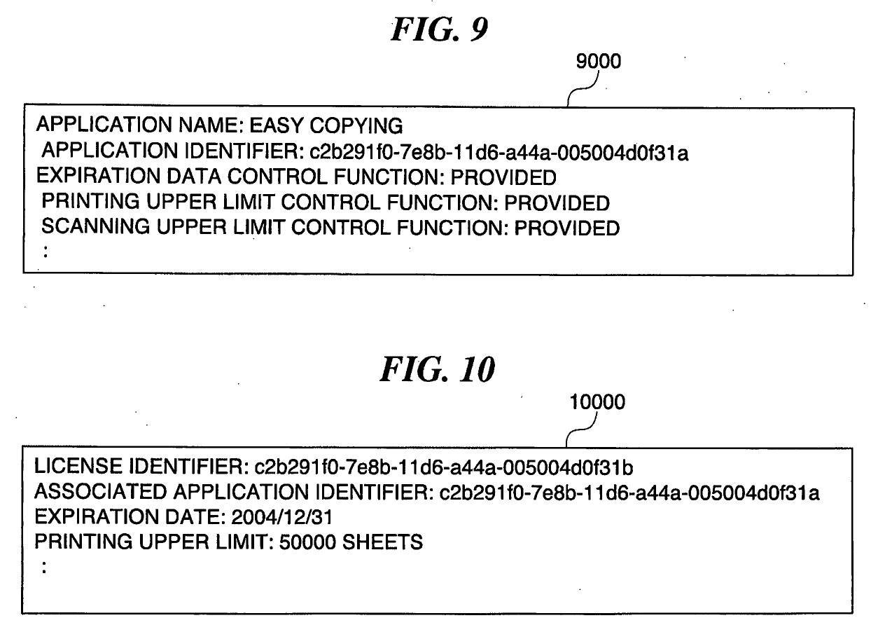

FIG. 9 shows an example of the configuration of property information 9000 on each application 2003 operating under the application execution environment 2000 of the MFP 3001 (3003). The property information 9000 in FIG. 9 indicates that the application name of the application 2003 is “easy copying”, and the application identification information is [c2b291f0-7e8b-11d6-a44a-005004d0f31a], and that the application 2003 has an expiration date control function, a printing upper limit control function, and a scanning upper limit control function.

FIG. 10 shows an example of the configuration of license information 10000 associated with the application 2003 operating under the application execution environment 2000 of the MFP 3001 (3003). The license information 10000 in FIG. 10 indicates that the license identification information is [c2b291f0-7e8b-11d6-a44a-005004d0f31b], and the identification information on the associated application 2003 is [c2b291f0-7e8b-11d6-a44a-005004d0f31a], and that the expiration date is set to “December 31, 2004”, and the printing upper limit is set to “50000 sheets”.

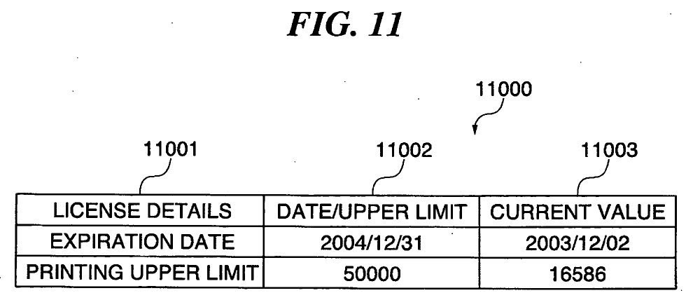

FIG. 11 shows an example of the configuration of management information 11000 managed by the license information management section 2006 of the MFP 3001 (3003). The management information 11000 exists in a one-to-one correspondence with each of the applications 2003, and manages the content of each license item and the current status of thereof.

As shown in FIG. 11, the management information 11000 is comprised of license details (items) 11001, a date/upper limit 11002, and a current value 11003 of each license item. The example in FIG. 11 indicates that “expiration date” and “printing upper limit” are set to the license details 11001; the date/upper limit 11002 of the “expiration date” is set to “December 31, 2004”; and the current value 11003 of the date is “December 2, 2003”. Further, it is indicated that the date/upper limit 11002 of the “printing upper limit” is set to “50000 sheets” and the current value 11003 of the number of printed sheets is “16586 sheets”.

It should be noted that the date/upper limit 11002 of a license can be changed by updating the license. Further, depending on an application, other items, such as “scanning upper limit”, etc., can be set to license items in addition to the “expiration date” and the “printing upper limit”.

FIG. 12 is a diagram of a license update configuration screen 12000 displayed on the display section of the operating section 1012 by the license information update configuration section 2009 of the MFP 3001 (3003). In a list box 12001 on the license update configuration screen. 12000, the application names of the applications managed by the application management section 2002 are displayed one by one by drop-down operation.

When a predetermined application is selected on the list box 12001, entry of various kinds of license configuration information associated with the selected application in the other entry boxes on the license update configuration screen 12000 is allowed. If there have already been set the values of configuration information on the selected application which correspond to the other entry boxes, the values are displayed in the other entry boxes, respectively.

A check box 12002 is used to specify whether or not a license for an application currently displayed in the list box 12001 is to be automatically updated. When the check box 12002 is checked, input operation is enabled from then on. A check box 12003 is used to specify whether or not a date is to be set at which the license is automatically updated. When the check box 12003 is checked and a desired date is entered in an entry box 12004, the license for the application currently displayed in the list box 12001 is automatically updated when an expiration date arrives or the printing upper limit is reached, before the date entered in the entry box 12004.

A check box 12005 is used to specify whether or not the number of times of execution of automatic license update is to be set. When the check box 12005 is checked and a desired number of times is entered in an entry box 12006, the license for the application currently displayed in the list box 12001 is automatically updated the number of times entered in the entry box 12006. After the number of times of execution of automatic update is set, the number is decremented whenever the license is automatically updated, and the remaining number of times of execution of automatic update is always displayed in the entry box 12006.

A check box 12007.is used to specify how many days before the expiration, the license is to be automatically updated, and a check box 12008 is used to specify how many sheets are to be left when the license is automatically updated before the number of printed sheets reaches the printing upper limit.

A check box 12009 is used to specify whether or not information on the automatic update of the license is to be sent to a predetermined destination when the license is automatically updated. When the check box 12009 is checked, delivery of information on the automatic update of the license is performed based on information entered in entry boxes mentioned below.

An entry box 12010 is used to enter notification destination information. In the present embodiment, it is assumed that an electronic mail address of a manager is entered as the notification destination information. A check box 12011 is used to specify how many days before execution of automatic update of the license based on expiration date, a notification of the automatic update is to be sent. When the check box 12011 is checked and a desired day count is entered in an entry box 12012, the notification of the automatic update is sent to the above-mentioned electronic mail address at a time point when the number of days left before the expiration date has become equal to the entered day count.

A check box 12013 is used to specify how many sheets are to be left when notification of execution of the automatic update based on the printing upper limit is performed. When the check box 12013 is entered and a desired sheet count is entered in an entry box 12014, the notification of execution of the automatic update is sent to the above-mentioned electronic mail address at a time point when the number of remaining sheets counted from the printing upper limit becomes equal to the entered sheet count. A check box 12015 is used to specify whether or not notification is to be performed after execution of the automatic update of the license. An OK button 12016 is used to finalize information set on the license update configuration screen 12000. When the OK button 12016 is clicked, the information set on the license update configuration screen 12000 is stored in a predetermined area in the RAM 1002. A cancel button 12017 is used to cancel the information set on the license update configuration screen 12000. When the OK button 12016 or the cancel button 12017 is clicked, the screen is switched to a previous screen, not shown, displayed immediately before the license update configuration screen 12000 is displayed.

Although in the present embodiment, information on the configuraiton of automatic license update is stored in the RAM 1002 as described above, it can be stored in a desired one of suitable memories including nonvolatile memories, such as the HDD 1004. Further, notification destination information associated with automatic update of a lecense is not limited to an electronic mail address, but other information, such as information for identifying a manager's PC, or an IP address, may be used as the notification destination information. Furthermore, the license update configuration screen 12000 can be displayed not on the operating section 1012 of the MFP 3001 (3003), but e.g. on the display section of a PC 3002 on the network. In this case, automatic license update information is configured from the PC 3002.

Moreover, the day count can be entered in the entry box 12012 under a setting configured such that the notification of automatic update is performed not at the time point when the number of days left before expiration of a license has become equal to the entered day count, but at a time point when the number of days left before actual execution of the automatic update of the license to be performed based on the day count entered in the entry box 12007 has become equal to the day count entered in the entry box 12012. For a similar effect, the sheet count can be entered in the entry box 12014 under a setting configured such that notification of automatic update is performed not at the time point when the number of remaining sheets counted from the printing upper limit has become equal to the entered sheet count, but at a time point when the number of remaining sheets left before actual execution of the automatic update of the license to be performed based on the sheet count entered in the entry box 12008 has become equal to the sheet count entered in the entry box 12014.

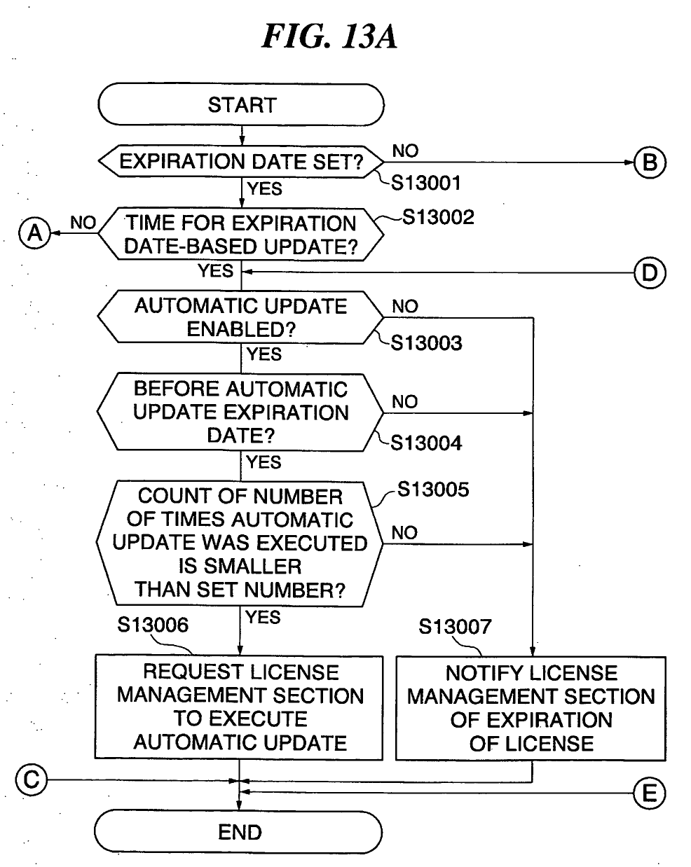

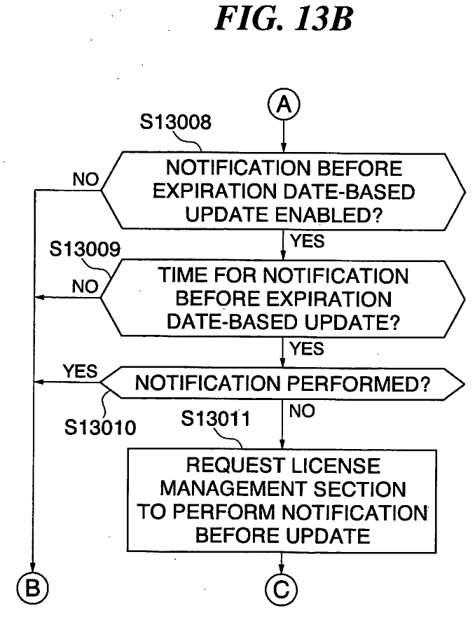

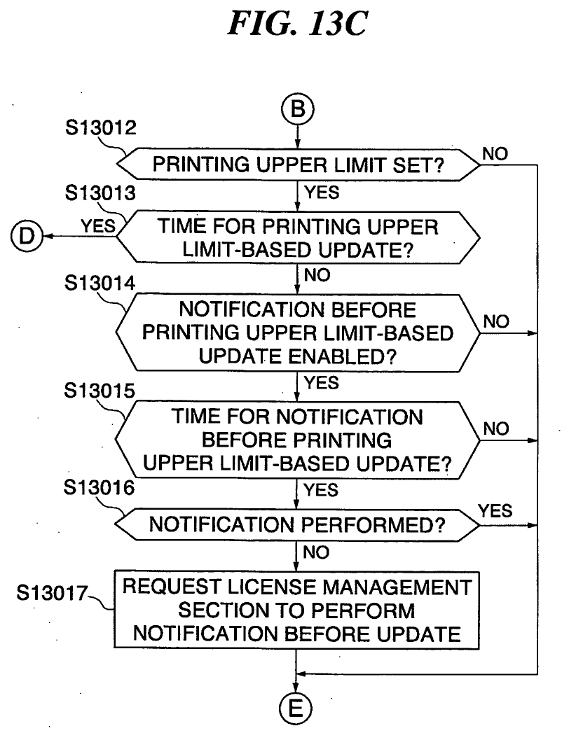

Next, a process which is executed by the license information management section 2006 of the MFP 3001 (3003) will be described with reference to a flowchart shown in FIGS. 13A to 13C. The present process is executed whenever a date or a printing sheet count is changed.

First, the license information management section 2006 determines whether or not an expiration date has been set in the management information 11000 in FIG. 11 (step S13001). If an expiration date has not been set in the management information 11000, the process proceeds to a step S13012. If an expiration date has been set in the management information 11000, the license information management section 2006 determines whether or not it is time for automatic license update based on the expiration date (step S13002). This determination processing is carried out based on entries of the date/upper limit 11002 and the current value 11003 associated with the expiration date in the management information 11000, and an entry of update timing configuration information associated with the expiration date in the entry box 12007 in FIG. 12.

If it is not time for automatic license update based on the expiration date, the process proceeds to a step S13008, described hereinafter. On the other hand, if it is time for automatic license update, the license information management section 2006 determines whether or not the check box 12002 in FIG. 12 are checked, to thereby determine whether or not automatic license update is enabled (step S13003). If automatic license update is enabled, the license information management section 2006 determines whether or not the current date, i.e. the current value 11003 associated with the expiration date contained in the management information 11000 is before an automatic update expiration date entered in the entry box 12004 in FIG. 12 (step S13004).

If it is before the automatic update expiration date, the license information management section 2006 determines whether or not a count of the number of times the automatic update was executed is smaller than the number of times of execution of automatic update set via the input box 12006 (step S13005). This determination processing is carried out based on whether or not the remaining number of times of execution of automatic update to be displayed in the entry box 12004 in FIG. 12 is equal to or larger than 1. If the count is smaller than the set number of times of execution of automatic update, the license information management section 2006 requests the license management section 2005 to execute automatic license update (step S13006).

If automatic license update is not enabled, or if it is after the automatic update expiration date, or if the count is not smaller than the number of times of execution of automatic update, the license information management section 2006 notifies the license management section 2005 that the license has expired (step S13007).

If it is determined in the step S13002 that it is not time for automatic license update based on the expiration date, the license information management section 2006 determines whether or not notification before the execution of automatic license update based on the expiration date is enabled (step S13008). This determination processing is carried out based on whether or not the check bxes 12009 and 12011 in FIG. 12 are checked. If the notification before the execution of automatic license update based on the expiration date is enabled, the license information management section 2006 determines, based on a day count entered in the entry box 12012 in FIG. 12 and the entries of the date/upper limit 11002 and the current value 11003 associated with the expiration date in the management information 11000, whether or not it is time for update notification before the execution of automatic license update based on the expiration date (step S13009).

If it is time for update notification before the execution of automatic license update based on the expiration date, the license information management section 2006 determines whether or not the update notification before the execution of automatic license update based on the expiration date has been performed yet (step S13010). If the update notification has not been performed yet, the license information management section 2006 requests the license management section 2005 to perform the update notification before the execution of automatic license update based on the expiration date (step S13011). This determination processing in the step S13010 is carried out based on information on the executed notifications (the executed notification information), including notification date information, stored in the RAM 1002 together with the configuration information in FIG. 12. The executed notification information is stored by the license management section 2005.

If the notification before the execution of automatic license update based on the expiration date is not enabled, or if it is not time for update notification before the execution of automatic license update based on the expiration date, or if the update notification before the execution of automatic license update based on the expiration date has already been performed, the process proceeds to the step S13012.

In the step S13012, the license information management section 2006 determines whether or not a printing upper limit has been set in the management information 11000 in FIG. 11. If no printing upper limit has been set, the process of the present flowchart is terminated, whereas if a printing upper limit has been set, the license information management section 2006 determines whether or not it is time for automatic license update based on the printing upper limit (step S13013). This determination processing is carried out based on entries of the date/upper limit 11002 and the current value 11003 associated with the printing upper limit in the management information 11000, and an entry of update timing configuration information associated with the printing upper limit in the entry box 12008 in FIG. 12.

If it is time for automatic license update based on the printing upper limit, the license information management section 2006 executes the aforementioned steps S13003 to S13006. On the other hand, if it is not time for automatic license update based on the printing upper limit, the license information management section 2006 determines whether or not notification before the execution of automatic license update based on the printing upper limit is enabled (step S13014). This determination processing is carried out based on whether or not the check boxes 12009 and 12013 in FIG. 12 are checked. If the notification before the execution of automatic license update based on the printing upper limit is enabled, the license information management section 2006 determines, based on a sheet count entered in the entry box 12014 in FIG. 12 and the entries of the date/upper limit 11002 and the current value 11003 associated with the printing upper limit in the management information 11000, whether or not it is time for update notification before the execution of automatic license update based on the printing upper limit (step S13015).

If it is determined that it is time for update notification before the execution of automatic license update based on the printing upper limit, the license information management section 2006 determines whether or not the update notification before the execution of automatic license update based on the printing upper limit has been performed yet (step S13016). If the update notification has not been performed yet, the license information management section 2006 requests the license management section 2005 to perform the update notification before the execution of automatic license update based on the printing upper limit (step S13017). The determination processing in the step S13016 is carried out based on information on the executed notifications (the executed notification information), including notification date information, stored in the RAM 1002 together with the configuration information in FIG. 12. The executed notification information is stored by the license management section 2005.

If notification before the execution of automatic license update based on the printing upper limit is not enabled, or if it is not time for update notification before the execution of automatic license update based on the printing upper limit, or if the update notification before the execution of automatic license update based on the printing upper limit has already been performed, the process of the present flowchart is terminated.

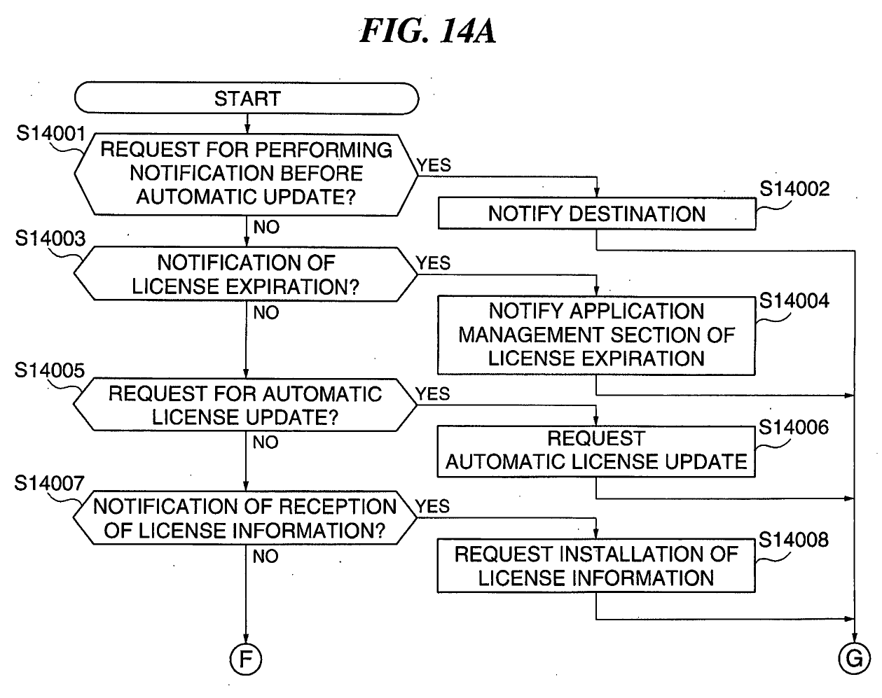

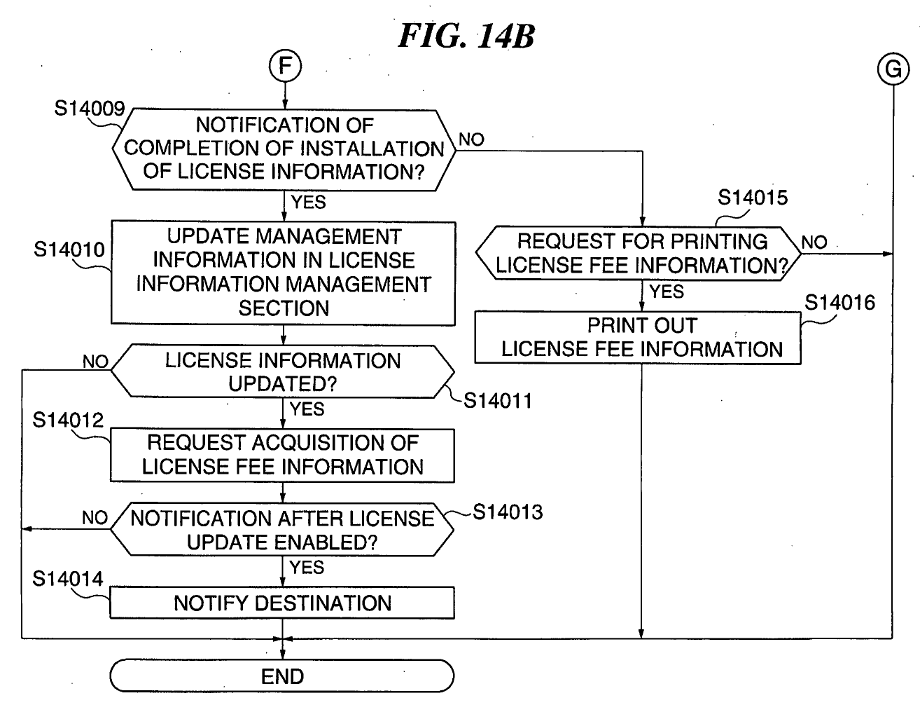

Next, a process which is executed by the license management section 2005 will be described with reference to flowcharts shown in FIGS. 14A and 14B. The process of the present flowchart is executed in response to events sent from the sections (software) of the application execution environment 2001 in FIG. 2.

First, the license management section 2005 determines whether or not a received event is a request for performing the notification before execution of automatic update of license information, from the license information management section 2006, i.e. the notification request issued in the step S13011 or S13017 in FIGS. 13B and 13C (step S14001). If the received event is the notification request issued in the step S13011 or S13017 in FIGS. 13B and 13C, the license management section 2005 performs notification responsive to the notification request, i.e. update notification before automatic license update based on the expiration date or the printing upper limit, by addressing a notification to an electronic mail address entered in the entry box 12010 in FIG. 12 (step S14002).

If the received event is not the notification request issued in the step S13011 or S13017 in FIGS. 13B and 13C, the license management section 2005 determines whether or not the received event is the notification of license expiration from the license information management section 2006 in the step S13007 in FIG. 13A (step S14003). If the received event is the notification of license expiration in the step S13007 in FIG. 13A, the license management section 2005 notifies the application management section 2002 that a license for a predetermined application has expired (step S14004). In this notification processing, the license management section 2005 acquires application indentification information from the notification information received from the license information management section 2006 and delivers the information indicative of the license expiration to the application management section 2002 together with the application indentification information. Upon reception of this notification, the application management section 2002 executes predetermined processing for inhibiting activation of the application whose license has expired.

If the received event is not the notification of license expiration, the license management section 2005 determines whether or not the received event is the automatic license update request issued from the license information management section 2006 in the step S13006 in FIG. 13A (step S14005). If the received event is the automatic license update request issued in the step S13006 in FIG. 13A, the license management section 2005 instructs the automatic license information issuance-requesting section 2007 to execute predetermined automatic license update processing (step S14006). In response to this instruction, the automatic license information issuance-requesting section 2007 sends to the PC 3002 an automatic license issuance-requesting command containing application identification information and license identification information contained in the instruction information from the license management section 2005. On the other hand, the PC 3002 sends to the MFP 3001 (3003) on the requesting side, license information for issuing a license anew or permitting update of a license, in response to the command from the automatic license information issuance-requesting section 2007.

If the received event is not the automatic license update request, the license management section 2005 determines whether or not the received event is a notification of reception of license information from the license information-receiving section 2008 (step S14007). If the received event is a notification of reception of license information, the license management section 2005 instructs the license information installation section 2004 to install the license information received by the license information-receiving section 2008 (step S14008).

If the received event is not a notification of reception of license information, the license management section 2005 determines whether or not the received event is a notification of completion of installation of license information from the license information installation section 2004 (step S14009). If the received event is a notification of completion of installation of license information, the license management section 2005 updates the management information in the license information management section 2006, and sets an update flag (step S14010). In this case, when the installation of the license information is performed along with installation of a new application, the license management section 2005 adds license information formatted as shown in FIG. 11 for the application to the license information management section 2006, whereas when license information on an existing application is installed, the license management section 2005 overwrites existing license information stored in the license information management section 2006 with the license information on the existing application.

Next, the license management section 2005 determines, based on the update flag, whether or not the license information has been updated in the step S14010 (step S14011). If the update flag has not been set, which means that the license information has not been updated, the license management section 2005 terminates the process of the present flowchart, whereas if the update flag has been set, which means that the license information has been updated, the same sends associated license identification information to the license fee acquisition section 2010 and instructs the same section 2010 to acquire associated license fee information (step S14012). In this case, the license fee acquisition section 2010 sends to the PC 3002 a license information notification requesting command containing the application identification information and the license identification information supplied from the license management section 2005. On the other hand, the PC 3002 sends to the MFP 3001 (3003) on the requesting side, license fee information associated with the application identification information and the license identification information contained in the command from the license fee acquisition section 2010.

Then, the license management section 2005 determines whether or not the check box 12009 and the check box 12015 in FIG. 12 are both checked, to thereby determine whether or not update notification after automatic update of license information has been configured to be executed (step S14013). If the check box 12009 and the check box 12015 in FIG. 12 are not both checked, i.e. if update notification after the automatic update of license information is not enabled, the license management section 2005 terminates the process of the present flowchart. On the other hand, if the check box 12009 and the check box 12015 in FIG. 12 are both checked, i.e. if update notification after the automatic update of license information is enabled, the license management section 2005 performs the update notification after the automatic update of license information by addressing a notification to an electronic mail address entered in the entry box 12010 in FIG. 12 (step S14014).

If the received event does not concern the installation of the license information, i.e. a notification of completion of installation of the same (No to the step S14009), the license management section 2005 determines whether or not the received event is a request for printing the license fee information sent from the license fee acquisition section 2010 (step S14015). If the received event is a request for printing the license fee information, the license management section 2005 generates print data formatted as a bill and instructs the printer 1095 to print out the generated print data (step S14016).

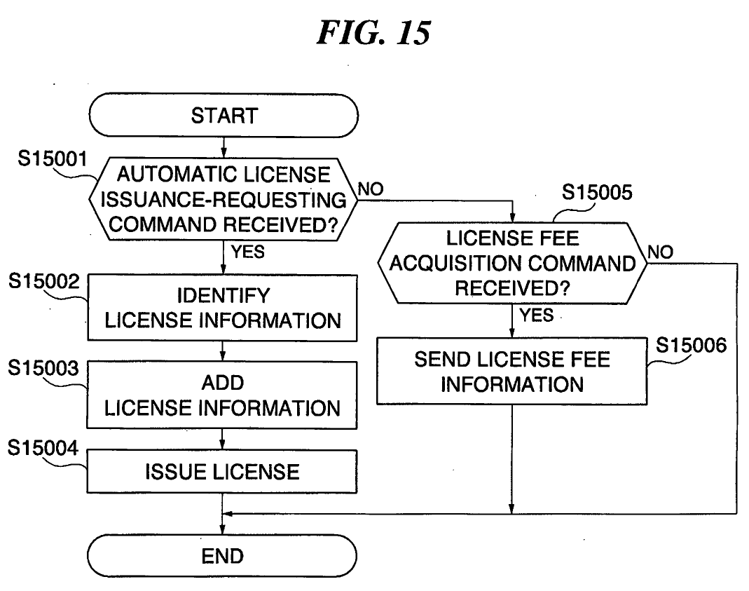

Next, a process which is executed by the PC 3003 upon reception of a command from the MFP 3001 or 3003 will be described with reference to a flowchart in FIG. 15.

First, the CPU 4001 of the PC 3002 determines whether or not an automatic license issuance-requesting command has been received via the communication I/F 4008 (step S15001). If it is determined that an automatic license issuance-requesting command has been received, the CPU 4001 identifies license information associated with the automatic license issuance request based on information contained in the automatic license issuance-requesting command (step S15002).

In this case, the CPU 4001 searches the application management information 5000 in FIG. 5 for application identification information identical to that in the automatic license issuance-requesting command to thereby identify an application associated with the automatic license issuance request. Further, the CPU 4001 retrieves license history information 8000 in FIG. 8, which contains license identification information identical to that in the automatic license issuance-requesting command, and then searches the license management information 7000 for license information 7001 associated with the retrieved license history information 8000 to thereby identify the license information associated with the automatic license issuance request.

Next, the CPU 4001 adds new history information to the license history information 8000 in FIG. 8, which contains the license identification information identical to that in the automatic license issuance-requesting command (step S15003). At this time, the CPU 4001 assigns a new license identification number to a license to be issued this time. Then, the CPU 4001 sends new license information to the MFP 3001 or 3003 which sent the automatic license issuance-requesting command (step S15004).

If it is determined in the step S15001 that no automatic license issuance request has been received, the CPU 4001 determines whether or not a license fee acquisition command has been received (step S15005). If it is determined that a license fee acquisition command has been received, the CPU 4001 sends license fee information associated with license identification information contained in the license fee acquisition command to the MFP 3001 or 3003 which sent the license fee acquisition command (step S15006).

As described above, according to the first embodiment, automatic update information associated with automatic update of a license is set in advance on the license update configuration screen 12000 displayed on the operating section 1012 of a multi-function device, whereby the update of the license is automatically performed based on the automatic update information. This makes it unnecessary to manually update or renew the license before the license expires, which enhances the user's convenience.

In a second embodiment of the present invention, the PC 3002 manages a plurality of multi-function devices divided into a plurality of groups, and each group has a multi-function device set as a representative multi-function device representing the group. Further, in the second embodiment, only the representative multi-function devices of the respective groups set by the PC 3002 request the PC 3002 to send license fee information, and the PC 3002 sends the total value of license fees for licenses updated for the multi-function devices in each group to the representative multi-function device of the group.

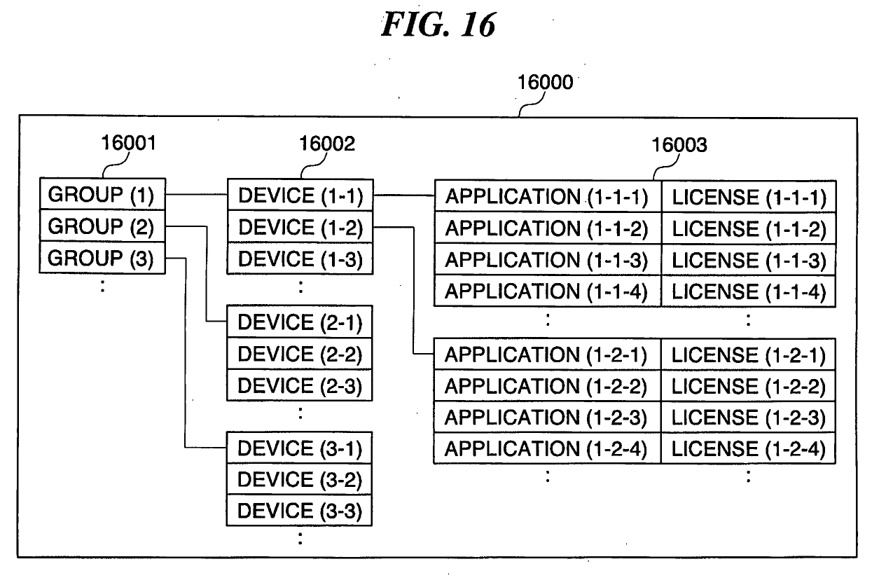

FIG. 16 shows an example of the configuration of group management information 16000 held by the PC 3002 in the second embodiment. This group management information 16000 is stored in a disk 4007 of the PC 3002 and used by being loaded into a RAM 4002 (which is also the case with a license fee management table 17000, described below). The group management information 16000 is comprised of group identification information 16001, identification information 16002 on multi-function devices (devices) belonging to each group, and application/license identification information 16003 containing identification information on each of applications installed in each multi-function device and identification information on a license for each aplication.

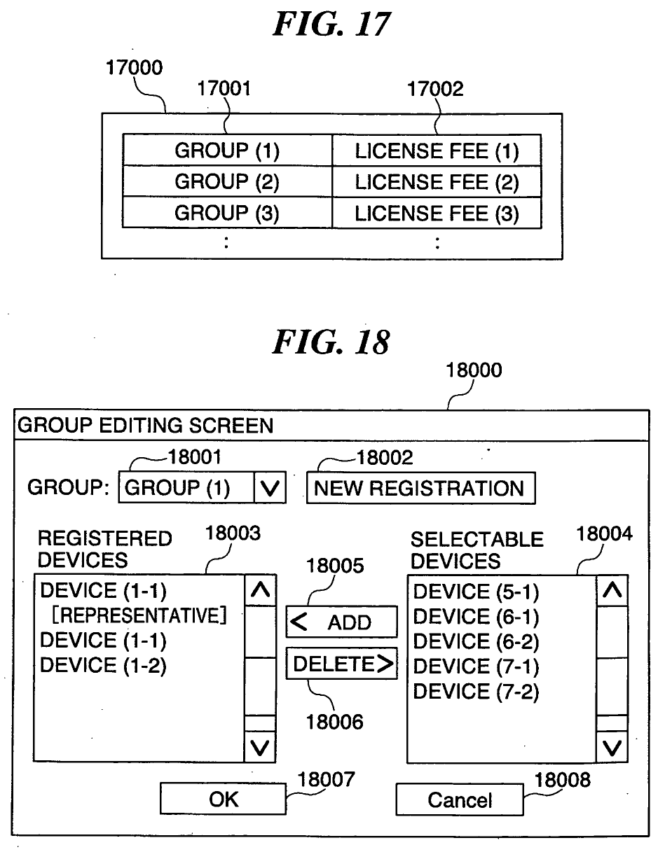

FIG. 17 shows an example of the configuration of the license fee management table 17000 held by the PC 3002 in the second embodiment. This license fee management table 17000 is also stored in the disk 4007 of the PC 3002 and used by being loaded into the RAM 4002. In the license fee management table 17000, there is registered a total value 17002 of license fees for licences updated for the multi-function devices (devices) belonging to each of the groups in association with each piece of group identification information 17001 (corresponding to the group identification information 16001 in FIG. 16).

In the present embodiment, it is assumed that the representative multi-function device in each group is the last one to request automatic license update, and the total value of license fees associated with respective licenses updated during a time period from acceptance of an automatic license update request from an arbitray one of the multi-function devices in each group to processing of the automatic license update request from the representative multi-function device in the group is calcutated by the CPU 4001 and registered in the license fee management table 17000.

However, settings can also be configured such that the representative multi-function device in each group requests automatic license update first, and the total value of license fees associated with respective licenses updated within a predetermined time period after acceptance of the automatic license update request from the representative multi-function device is registered in the license fee management table 17000. Alternatively, settings can be configured such that each of the multi-function devices in each group requests an automatic license update in arbitrary timing, and the total value of license fees associated with respective licenses updated within a predetermined time period is registered in the license fee management table 17000.

FIG. 18 shows a group editing screen 18000 displayed on the display of the PC 3002 in the second embodiment. This group editing screen 18000 is used to prepare and edit the group management information 16000 shown in FIG. 16. In a list box 18001 provided in an upper part of the group editing screen 18000, the pieces of group identification information 16001 already registered can be displayed one by one by drop-down operation.

When a desired piece of the group identification information 16001 is selected on the list box 18001, a list of respective pieces of identification information on multi-function devices registered as ones belonging to the group identified by the selected identification information 16001 is displayed in a box 18003. In the list, the identification information on a multi-function device representative of the group is displayed as such. In the present embodiment, it is assumed that a multi-function device first assigned to each group is automatically set to a device representative of the group. Further, in a box 18004, a list of identification information on multi-function devices which are not yet registered in any group on the network 3004 is displayed from the beginning when the group editing screen 18000 is displayed.

It should be noted that when a new registration buton 18002 is clicked, the screen 18000 is switched to a screen, not shown, for new registration of group identification information. Further, when an item is selected from the list of identification information on multi-function devices displayed in the box 18004 and then an addition button 18005 is clicked, the selcted multi-function device is additionally assigned to a group selected on the list box 18001, and the identification information on the additionally assigned multi-function device is displayed in the box 18003. On the other hand, when an item is selected from the list of identification information on multi-function devices displayed in the box 18003 and then a delete button 18006 is clicked, the selcted multi-function device is deleted from the group selected on the list box 18001, and the identification information on the deleted multi-function device is erased from the box 18003 and displayed in the box 18004 as a selectable device.

An OK button 18007 is used to finalize information set on the group editing screen 18000, and a cancel button 18008 is used to cancel information set on the group editing screen 18000.

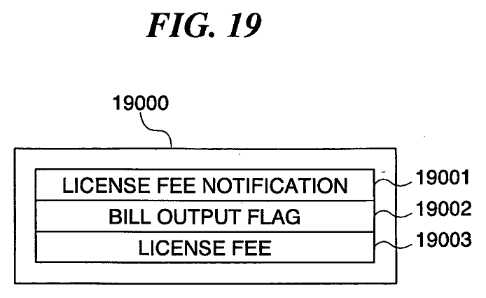

FIG. 19 shows example of the configuration of a license fee notification command 19000 to be sent to a multi-function device from the PC 3002 in the second embodiment. The license fee notification command 19000 is comprised of command identification information 19001 indicating that the command containing the same is a license fee notification command, a bill output flag 19002 that gives an instruction for issuance of a bill for a license fee, and license fee information 19003.

The license fee notification command 19000 is sent only to a multi-function device representative of a group. The bill output flag 19002 is always set to 1, i.e. a state for giving an instruction for issuance of a bill for a license fee. Further, the license fee information 19003 indicates the total value of license fees for respective licenses updated for multi-function devices belonging to the group.

Thus, according to the second embodiment, it is not required to carry out an operation or processing for calculating a total of license fees from the information on license fees on respective licenses updated for multi-function devices, which improves user's convenience.

It should be noted that the present invention is not limited to the above described embodiments, but can be applied to other devices and apparatuses than multi-function devices, for example. Further, in the second embodiment, the PC 3002 may send the total value of license fees to a multi-function device in the form of image data formatted as a bill.

Further, it is to be understood that the object of the present invention may also be accomplished by supplying a system or an apparatus with a storage medium in which a program code of software, which realizes the functions of either of the above described embodiments is stored, and causing a computer (or CPU or MPU) of the system or apparatus to read out and execute the program code stored in the storage medium.

In this case, the program code itself read from the storage medium realizes the functions of either of the above described embodiments, and therefore the program code and the storage medium in which the program code is stored constitute the present invention.

Examples of the storage medium for supplying the program code include a floppy® disk, a hard disk, a magnetic-optical disk, an optical disk such as a CD-ROM, a CD-R, a CD-RW, a DVD-ROM, a DVD-RAM, a DVD-RW, and a DVD+RW, a magnetic tape, a nonvolatile memory card, and a ROM. Alternatively, the program may be downloaded via a network from another computer, a database, or the like, not shown, connected to the Internet, a commercial network, a local area network, or the like.

Further, it is to be understood that the functions of either of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of either of the above described embodiments may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

This application claims the benefit of Japanese Application No. 2005-049156, filed Feb. 24, 2005, which is hereby incorporated by reference herein in its entirety.

What is claimed is:

1. A license management apparatus incorporated in an apparatus that executes a predetermined application, the license management apparatus managing a license for the application, comprising:
a storage device that stores license information concerning the license for the application;
a setting device that sets automatic update information concerning automatic update of the license for the application according to a input by a user;
a determination device that determines, based on the license information stored by said storage device and the automatic update information set by said setting device, whether or not it is time for updating the license; and
an update requesting device that requests update of the license when said determination device determines that it is time for updating the license.

2. A license management apparatus as claimed in claim 1, wherein said setting device sets at least one of an automatic update expiration date of the license and a number of times of execution of the automatic update, as the automatic update information.

3. A license management apparatus as claimed in claim 1, wherein said setting device sets timing in which the license is to be automatically updated before expiration of the license, as the automatic update information.

4. A license management apparatus as claimed in claim 1, wherein said setting device sets information for use in notifying that the license is to be or has been automatically updated, to a predetermined destination.

5. A license management apparatus as claimed in claim 4, wherein said setting means sets an electronic mail address as the information for use in the notification.

6. A license management apparatus as claimed in claim 4, wherein said setting means sets information on timing in which the notification is to be executed, as the information for use in the notification.

7. A license management apparatus as claimed in claim 1, comprising an acquisition device that is operable when a license which has been updated is issued from a server on a network in response to a request made by said update requesting device, to acquire a fee for the license from the server.

8. A license management apparatus as claimed in claim 7, comprising a transmission device that transmits the license fee acquired by said acquisition device to a predetermined management apparatus via the network.

9. A license management apparatus as claimed in claim 7, comprising a printing control device that causes a printing apparatus to print the license fee acquired by said acquisition device.

10. A license management apparatus as claimed in claim 7, wherein a plurality of the license management apparatuses are divided into groups by said server, and only a license management apparatus set to one representative of each group is provided with said acquisition device.

11. A license management apparatus as claimed in claim 10, wherein said acquisition device of said license management apparatus representative of each group acquires a total of fees for updates of licenses each requested by said update requesting device of each license management apparatus of the group, from the server.

12. A control method for a license management apparatus incorporated in an apparatus that executes a predetermined application, the license management apparatus managing a license for the application, comprising:
a storage step of storing license information concerning the license for the application;
a setting step of setting automatic update information concerning automatic update of the license for the application according to a input by a user;
a determination step of determining, based on the license information stored in said storage step and the automatic update information set in said setting step, whether or not it is time for updating the license; and
an updating requesting step of requesting update of the license when it is determined in said determination step that it is time for updating the license.

13. A program for causing a computer to execute a control method for a license management apparatus incorporated in an apparatus that executes a predetermined application, the license management apparatus managing a license for the application, comprising:
a storage module for storing license information concerning the license for the application;
a setting module for setting automatic update information concerning automatic update of the license for the application according to a input by a user;
a determination module for determining, based on the license information stored by said storage module and the automatic update information set by said setting module, whether or not it is time for updating the license; and
an updating requesting module for requesting update of the license when it is determined by said determination module that it is time for updating the license.
